(19) United States
(12) Patent Application Publication
(10) Pub. No.: US 2026/0030022 A1
(43) Pub. Date: Jan. 29, 2026

(54) CONTAINERIZATION USING SELF-LEARNED CONTAINER TEMPLATES

(71) Applicant: International Business Machines Corporation, Armonk, NY (US)

(72) Inventors: Yu Zui You, Ningbo (CN); Zhan Peng Huo, Beijing (CN); Tong Liu, Xi'an (CN); Teng Sun, BEIJING (CN)

(21) Appl. No.: 18/785,155

(22) Filed: Jul. 26, 2024

(51) Int. Cl. G06F 8/77

(52) U.S. Cl. CPC G06F 8/77

(57) ABSTRACT

A system may include a memory and a processor in communication with the memory. The processor may be configured to perform operations. The operations may include analyzing input source code and building a project instance based on the input source code. The operations may include matching a project instance to a template and generating, automatically, a command file based on the template.

### BACKGROUND

The present disclosure relates to containerization and distributed systems, and, more specifically, to workload dispatching in containerized systems.

Workload dispatching is a common function in the computer field, including in distributed systems such as container systems. Software uses installation media, and the installation media may depend on the deployment method. Different deployment methods have different mechanisms; for example, a software may need images and containers built for containerized deployment. Developers may focus on the success of the construction of the software itself and not have the same expertise in the deployment mechanism.

Containers are a mechanism for software deployment that offer adaptive load balancing, service registration, deployment, operation, resource scheduling, and capacity scaling. As containerization is so versatile, employing an optimal container construction solution requires its own expertise, and expertise requires time to acquire. For containerization deployment, the use of the container deployment mechanism can impact the efficiency of the capacity of the system, the security of the files, the permissions of the container, the vulnerability of the containers used, and the like. Thus, although using optimal container construction is important, the expertise to do so can require substantial resource expenditure.

### SUMMARY

Embodiments of the present disclosure include a system, method, and computer program product for containerization, specifically, a containerization engine.

A system in accordance with the present disclosure may include a memory and a processor in communication with the memory. The processor may be configured to perform operations. The operations may include analyzing input source code and building a project instance based on the input source code. The operations may include matching a project instance to a template and generating, automatically, a command file based on the template.

A computer-implemented method in accordance with the present disclosure may include analyzing input source code and building a project instance based on the input source code. The method may include matching a project instance to a template and generating, automatically, a command file based on the template.

A computer program product in accordance with the present disclosure may include a computer readable storage medium having program instructions embodied therewith. The program instructions may be executable by a processor to cause the processor to perform a function. The function may include analyzing input source code and building a project instance based on the input source code. The function may include matching a project instance to a template and generating, automatically, a command file based on the template.

The above summary is not intended to describe each illustrated embodiment or every implementation of the disclosure.

### BRIEF DESCRIPTION OF THE DRAWINGS

The drawings included in the present application are incorporated into, and form part of, the specification. They illustrate embodiments of the present disclosure and, along with the description, serve to explain the principles of the disclosure. The drawings are only illustrative of certain embodiments and do not limit the disclosure.

FIG. 1 illustrates a containerization engine system architecture in accordance with some embodiments of the present disclosure.

FIG. 2 depicts a project container template generation module architecture in accordance with some embodiments of the present disclosure.

FIG. 3 illustrates a template matcher and dockerfile generation module architecture in accordance with some embodiments of the present disclosure.

FIG. 4A depicts a flowchart of an example graph embedding in accordance with some embodiments of the present disclosure.

FIG. 4B illustrates a flowchart of an example template matcher and command file generation implementation in accordance with some embodiments of the present disclosure.

FIG. 5 depicts a runtime execution module architecture in accordance with some embodiments of the present disclosure.

FIG. 6 illustrates a first example implementation of a containerization engine in accordance with some embodiments of the present disclosure.

FIG. 7 depicts a second example implementation of a containerization engine in accordance with some embodiments of the present disclosure.

FIG. 8 illustrates a computer-implemented method of containerization using a containerization engine in accordance with some embodiments of the present disclosure.

FIG. 9 depicts computer-implemented method of containerization using a containerization engine in accordance with some embodiments of the present disclosure.

FIG. 10 illustrates a block diagram illustrating an embodiment of a computer system configured to operate in a network environment (including a cloud environment), and the components thereof, upon which embodiments including systems and methods described herein may be implemented in accordance with the present disclosure.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention.

### DETAILED DESCRIPTION

Aspects of the present disclosure relate to containerization and distributed systems, and, more specifically, to workload dispatching in containerized systems.

Containers are a mechanism for software deployment that offer adaptive load balancing, service registration, deployment, operation, resource scheduling, and capacity scaling. When developers are completing the development of software, they need to build the installation media for the codes. Based on various advantages of containerized deployment, the development team may choose container method for deployment; however, the developers may encounter various problems when building the optimal images and containers.

Specifically, developers may have no experience in containerized deployment and thus may not know how to build images and containers; to adapt, they may need to spend a lot of time to learn the knowledge of the system to build the images and containers. Moreover, developers often focus on the success of the construction, but do not consider the optimal container construction solution; as a result, the development team may build large images and waste system capacity. Further, the developers may lack consideration for the security of the images; the image may have many security issues such as not considering the running permissions of the container, the vulnerability of the container, and the like. Additionally, for some special configurations within an enterprise, some external tools cannot directly meet the construction needs; this results in the developers needing to conduct research to optimize the container for the intended use. Furthermore, developers may spend the time to learn information about containerization, but the pace of updates may exceed the time allotted for such learning, leading to the developers learning information according to out-of-date guidance and practices; this may result in building images with bugs and/or vulnerabilities and giving the developers a false sense of security.

Thus, the use of the container deployment mechanism for containerization deployment can impact the efficiency of the capacity of the system, the security of the system, and the like. Although using optimal container construction is important at least for efficiency and security, the expertise to optimize containerization can require substantial resource expenditure.

The present disclosure discusses a mechanism to automatically build container images with a sample command or tool and enables running containers to provide applications or services based on source codes. The disclosed mechanism is a containerization engine that includes three modules: a Project Command file Template Generation Module (PCTGM), a Template Match and Command file Generation Module (TMCGM), and a Runtime Execution Module (REM).

The Project Container Template Generation Module (PCTGM) intelligently learns and analyzes collected project codes and their corresponding command files (e.g., dockerfiles); the PCTGM may thus generate a series of Project Container Templates. (Note: the term “dockerfile” may be subject to trademark rights in various jurisdictions throughout the world and are used here only in reference to the products or services properly denominated by the marks to the extent that such trademark rights may exist.)

The PCTGM may include an nodes automatic classifier (which may also be referred to as an automatic node classifier or simply a node classifier). The node classifier may automatically classify feature nodes into defined schemas; in some embodiments, the node classifier may automatically cluster the nodes directly from the project code into certain graphs and the corresponding command files (e.g., dockerfiles).

The PCTGM may also include a project container template generator. The project container template generator may generate one or more project container templates based on the graphs and command files (e.g., dockerfiles) output from the nodes automatic classifier. The project container template may include one or more abstract graphs and the corresponding command file (e.g., dockerfile) template.

The PCTGM may learn and generate project container templates. Learning and generating project container templates may include extracting the features from the project code as feature nodes and the corresponding command file (e.g., dockerfile) such as programming language, dependencies, entry command, environments, and the like. Learning and generating project container templates may include using the nodes automatic classifier to automatically classify the feature nodes into defined schemas or automatically cluster the nodes directly from the project code to certain graphs and the corresponding command files (e.g., dockerfiles). Learning and generating project container templates may include using the project container template generator to cluster the abstract project container template based on the graphs and command files (e.g., dockerfiles) output from the nodes automatic classifier. The abstract project container template may include the abstract graph and the corresponding command file (e.g., dockerfile) template.

Template Matcher and Command file Generation Module (TMCGM) analyzes the project source code and performs matching work for existing project container templates. The TMCGM may then produce the command file (e.g., dockerfile) based on the project container template that was matched with the project source code.

The TMCGM may include a nodes automatic classifier (which may also be referred to as an automatic node classifier or simply a node classifier). The node classifier may automatically classify feature nodes into defined schemas; in some embodiments, the node classifier may automatically cluster the nodes directly from the project code into certain graphs.

The TMCGM may include a template matcher. The template matcher may match the graphs automatically generated by the nodes automatic classifier with one or more existing project container templates.

The TMCGM may include a command file generator. The command file generator may automatically generate the command file (e.g., dockerfile) for the project based on the project container template that was matched with the project source code.

The TMCGM analyzes project source code and performs matching work between the project source code and existing project container templates. The TMCGM may produce a command file (e.g., dockerfile) based on the matched project container template. The TMCGM may use a nodes automatic classifier to automatically classify the feature nodes into defined schemas, or rather, to automatically cluster the nodes directly from the project code to certain graphs. The TMCGM may use a template matcher to match graphs automatically generated by the nodes automatic classifier with one or more existing project container templates. The TMCGM may use a command file generator to automatically generate the command file (e.g., dockerfile) based on the project container template that was matched with the project source code.

The graph similarity calculation may use graph embedding. Given a pair of graphs, a graph may be represented as a vector and the similarity may be calculated according to the corresponding vector of the graph embedding. The correlation or difference between two graph nodes may also be considered. The first step may be to perform graph embedding. Graph embedding may include doing one-hot encoding to every node (the same node type has the same encoding) and then use a graph convolutional network (GCN) to conduct neighbor aggregation; in some embodiments, the GCN may use three layers or aggregate the characteristics of first-order neighbors of nodes. The graph embedding may include using an attention mechanism to merge node embeddings into graph embeddings.

A node feature update rule may be used to aggregate feature vectors of the neighbors of a node, normalize the feature vectors, and apply a linear transformation and a non-linear activation function. An example node feature update rule for a GCN is shown as equation 1.

$$conv ( {u}_{n} ) = σ ( {\sum }_{m ϵ N ( n )} ( ( \frac{1}{\sqrt{{d}_{n} {d}_{m}}} ) {u}_{m} {W}_{1}^{( l )} ) ) \qquad Eq . 1$$

Wherein uₙ is the feature vector of node n, N(n) is the first-order neighbors of node n, dₙ is the degree of node n (as in, the number of edges connected to node n),

$${W}_{1}^{( l )}$$

is the weight matrix of layer l, and σ is the activation function (e.g., ReLU).

The graph similarity calculation may include computing a representation c of the entire graph. The attention weight of each embedded node may be calculated by using c; c is a representation of the entire graph of information. The graph similarity calculation may represent an entire graph of information by taking the average (or approximate average) of all node features transformed by a weight matrix and passed through the tanh function. An example calculation of the representation of the entire graph c is shown in equation 2.

$$c = tan h ( ( \frac{1}{N} {\sum }_{n = 1}^{N} {u}_{n} ) {W}_{2} ) \qquad Eq . 2$$

Wherein c is a representation of the entire graph, tanh is the hyperbolic tangent activation function, N is the total number of nodes in the graph, and W₂ is the weight matrix.

The graph similarity calculation may include calculating a graph embedding vector h. The graph embedding vector h combines node feature vectors weighted by the attention score (the sigmoid of the dot product between the node feature and the graph representation vector) to form the graph embedding. In other words, the graph similarity calculation may include using a sigmoid function on the inner product of node information and full graph information to obtain a graph embedding vector. An example computation of the graph embedding vector h is shown in equation 3.

$$h = {\sum }_{n = 1}^{N} {f}_{2} ( {u}_{n}^{T} c ) {u}_{n} \qquad Eq . 3$$

Wherein h is the graph embedding vector, uₙ is the feature vector of node n, c is the graph representation vector (as calculated using, e.g., equation 2), and f₂ is the sigmoid function.

The TMCGM may use a neural tensor network to calculate similarity; in some embodiments, the input is two graph embeddings and the output is a k-dimensional similarity vector. The TMCGM may perform a pairwise node comparison to consider the relationship between the two graph nodes and the graph embedding inner product to get the correlation matrix; the correlation matrix may then be transformed into histogram feature. The TMCGM may perform a similarity calculation; the similarity calculation may include calculation of a neural network output vector and pairwise similarity of node histogram characteristics obtained by the comparison. In some embodiments, the TMCGM may use several layers of the link layer to obtain the final dimension compressed similarity score. The neural tensor network may represent the interaction between two graph embeddings hᵢ and hⱼ. An example similarity calculation is shown in equation 4.

$$g ( {h}_{i} , {h}_{j} ) = {f}_{3} ( {h}_{i}^{T} {W}_{3}^{[ 1 : K ]} {h}_{j} + V [ \begin{matrix}{h}_{i} \\ {h}_{j}\end{matrix} ] + {b}_{3} ) \qquad Eq . 4$$

Wherein g is the similarity, hᵢ and hⱼ are graph embedding vectors,

$${W}_{3}^{[ 1 : K ]}$$

is a tensor of weights that represents multiple slices, V is a weight matrix, b₃ is a bias term, ∥ is a concatenation operator, and f₃ is an activation function (e.g., ReLU).

The PCTGM may also include a Runtime Execution Module (REM). The REM may automatically update the command file (e.g., dockerfile) to generate a new container image and start a container to provide secured, optimized applications and/or services. The REM may include an automatic error correction component. The automatic error correction component may automatically try to correct the command file (e.g., dockerfile) to an executable one. For example, the automatic error correction component may detect a problem with the command file, identify a solution to the detected problem, and correct the problem using the solution identified. In some embodiments, the automatic error correction component may perform one or more of the operations automatically (e.g., automatically detect a problem, automatically identify a solution, and notify an administrator of the detected problem and identified solution); in some embodiments, the automatic error correction component may perform all of the operations automatically (e.g., automatically detects a problem, automatically identifies a solution, and automatically corrects the detected problem with the identified solution).

Examples of feature nodes that may be extracted from a main source code are LibreOffice, openjdk, java, timezone, MySQL, SpringBoot, VUE, React, and the like. Examples of feature nodes that may be extracted from an application.yml source code configuration file are DB_NAME, DB_PWD, DB_USER, DB_Port, and the like. Examples of feature nodes that may be extracted from a pom.xml source code configuration file are java 1.8, tika, Lombok, package plugin, and the like. The feature nodes may be clustered to generate a graph, for example, by using the clustering schemas discussed herein. For example, clustering these example feature nodes may result in the compile tool cluster including openjdk, the language may include java, the backend framework may be SpringBoot, the frontend framework may include VUE and/or React, the database cluster may include DB_NAME, DB_PWD, DB_USER, DB_Port, and MySQL, and the dependencies may include LibreOffice, timezone, tika, Lombok, and package plugin.

The teachings of the present disclosure may be more readily understood by use of example. One example of implementing the present disclosure a java project is as follows.

First, the PCTGM may extract the feature nodes from the source code and the command file (e.g., the dockerfile) of the project. Next, the PCTGM may use the nodes automatic classifier to cluster the feature nodes and build a project template graph for the project. Then, the PCTGM may cluster the project container templates (based on the graphs and command files) and build up project container templates for each type; for example, the PCTGM may build a Java SpringBoot project container template, a python PyTorch project container template, and the like.

In another example, the PCTGM may extract the feature nodes from the source code (e.g., the application.yml and/or pom.xml codes) of a java project and the TMCGM may build the project instance for the java project. The TMCGM template matcher may be used to find the proper (e.g., matching) project container template; the project container template's command file (e.g., dockerfile) may be used as an example to generate the command file for the java project by the command file generator of the TMCGM. After the command file is generated, the automatic error correction component of the REM may scan and/or analyze the command file to find any problems (e.g., execution issues and/or vulnerabilities). The automatic error correction component may detect a problem, identify solutions, and use the best solution (as learned from project container template) to solve the problem. The REM may then build and execute the container image and the container; the REM may also will correct any runtime error detected.

The present disclosure may enable the automatic application of best practices (e.g., best command file practices) which may improve security and reduce vulnerabilities. The present disclosure may enable the automatic identification of different projects to build corresponding images and containers. The present disclosure may enable automatic error correction, and automatic error correction may verify the correctness of container image creation and container operation. The present disclosure may enable accelerating the container building knowledge learning curve and thereby help developers succeed in complex software projects. The present disclosure may enable optimization of container images creation and container deployment.

A system in accordance with the present disclosure may include a memory and a processor in communication with the memory. The processor may be configured to perform operations. The operations may include analyzing input source code and building a project instance based on the input source code. The operations may include matching a project instance to a template and generating, automatically, a command file based on the template.

In some embodiments of the present disclosure, the operations may further include obtaining input feature nodes from the input source code. In some embodiments, analyzing the input source code may result in obtaining the input feature nodes.

In some embodiments of the present disclosure, the operations may further include extracting feature nodes from a plurality of samples, building a template graph with the feature nodes, and generating a project container template based on the template graph. In some embodiments, the plurality of samples may include sample project codes and/or sample command files. In some embodiments, building the template graph may include classifying the sample feature nodes. In some embodiments, generating a project container template may include generating a template command file. In some embodiments, multiple project container templates may be generated, and the operations may include merging any duplicative templates.

In some embodiments of the present disclosure, the operations may further include generating a container image based on the command file.

In some embodiments of the present disclosure, the operations may further include generating a container based on the command file.

In some embodiments of the present disclosure, the operations may further include detecting a problem based on the command file; in some embodiments, the problem may be detected automatically. In some embodiments, the operations may further include identifying a solution to the problem; in some embodiments, the solution may be identified automatically. In some embodiments, the operations may further include correcting the problem using the solution; in some embodiments, the problem may be corrected using the solution automatically.

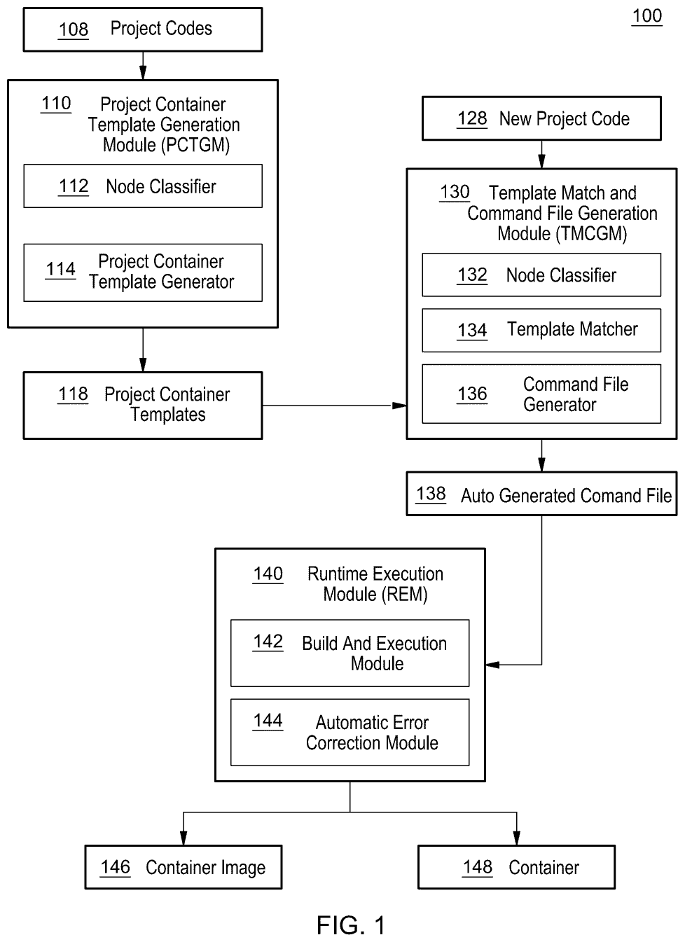

FIG. 1 illustrates a containerization engine 100 system architecture in accordance with some embodiments of the present disclosure. In some embodiments, the containerization engine 100 may offer self-learned container templates; in some embodiments, the containerization engine 100 may offer optimized and/or simplified containerization.

The containerization engine 100 may include a PCTGM 110. The PCTGM 110 may receive project codes 108; the project codes 108 may be used as input. The PCTGM 110 includes a node classifier 112. The PCTGM 110 may generate project container templates 118. The PCTGM 110 may use the project codes 108 to generate the project container templates 118; for example, the PCTGM 110 may receive a batch of project codes 108 (e.g., sample project codes from known projects) as an input and may use that input to generate a batch of project container templates 118 as an output.

The containerization engine 100 may include a TMCGM 130. The TMCGM 130 includes a node classifier 132, a template matcher 134, and a command file generator 136. The TMCGM 130 may receive the project container templates 118 from the PCTGM 110. The TMCGM 130 may also receive a new project code 128. The TMCGM 130 may automatically generate a command file 138. The TMCGM 130 may use the project container templates 118 and the new project code 128 to generate the automatically generated command file 138; for example, the TMCGM 130 may receive a batch of project container templates 118 and a new project code 128 as inputs and may use the inputs to generate the automatically generated command file 138 for the new project code 128 as an output.

The containerization engine 100 may include a REM 140. The REM 140 includes a build and execution module 142 and an automatic error correction module 144. The REM 140 may receive the automatically generated command file 138 for the new project code 128. The REM 140 may generate a container image 146 and execute a container 148. The REM 140 may use the automatically generated command file 138 to generate the container image 146 and execute the container 148 for the new project code 128; for example; the REM 140 may receive the automatically generated command file 138 as an input and generate as output the container image 146 and the container 148.

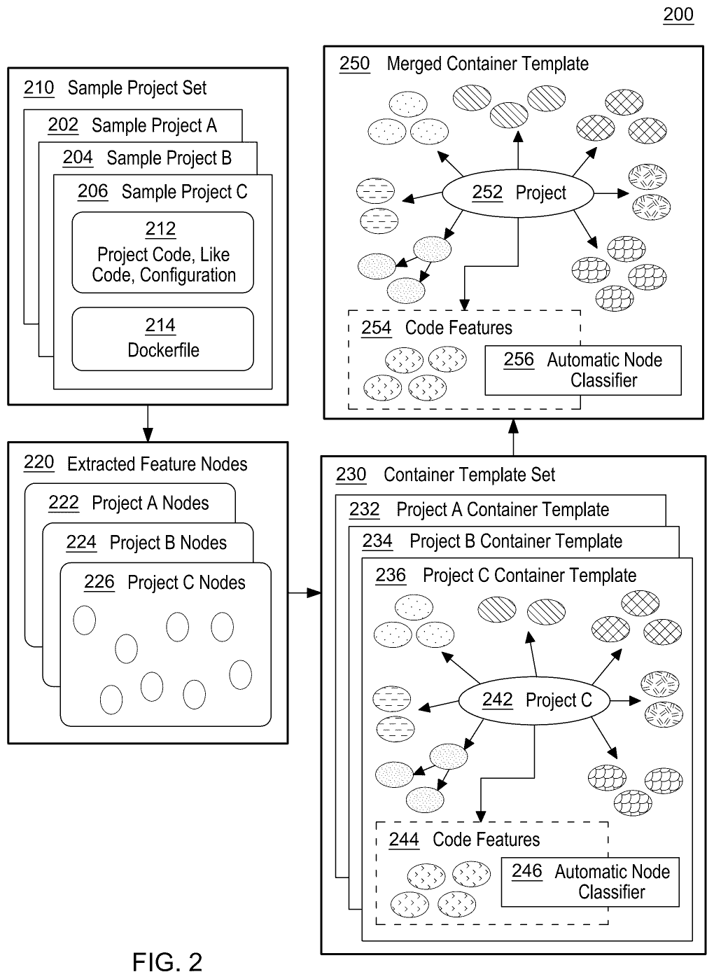

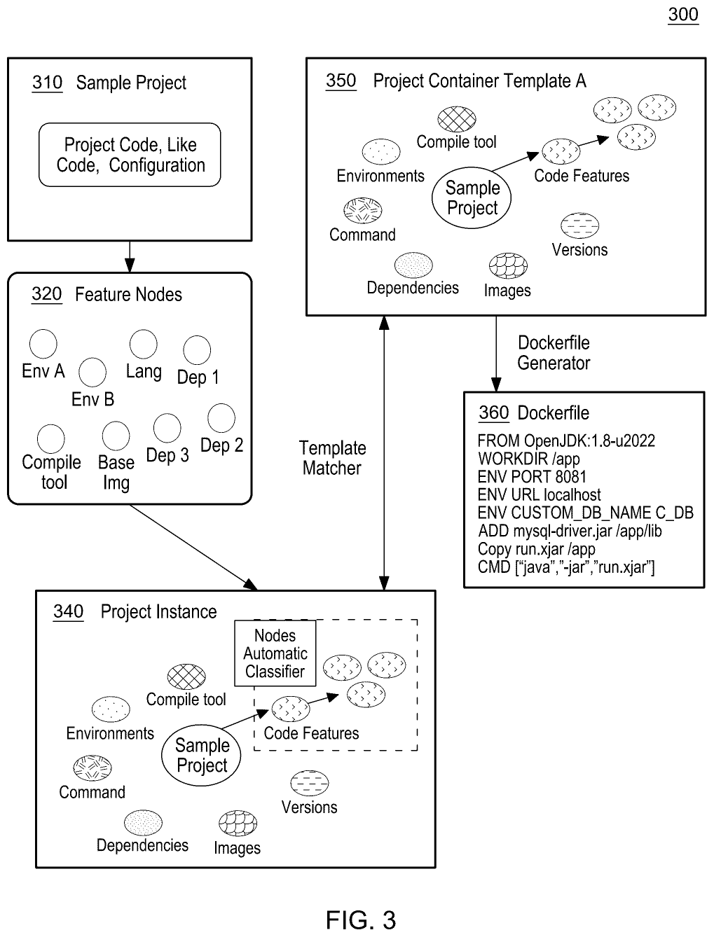

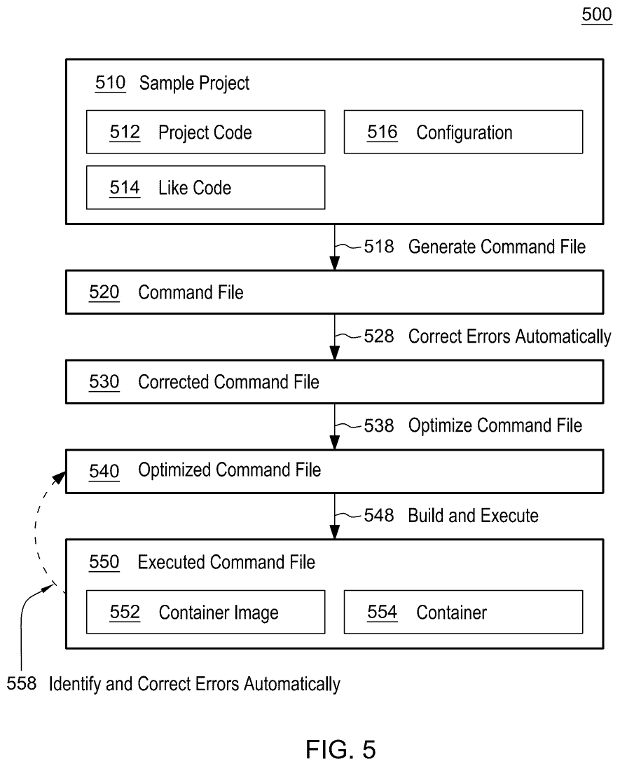

A containerization engine (e.g., containerization engine 100 as shown in FIG. 1) may include a PCTGM (e.g., PCTGM 200 shown in FIG. 2), a TMCGM (e.g., TMCGM 300 as shown in FIG. 3), and a REM (e.g., REM 500 as shown in FIG. 5). FIG. 2 depicts a PCTGM 200 architecture in accordance with some embodiments of the present disclosure. The PCTGM 200 may learn from a sample project set 210 and generate a container template set 230, then merging any duplicative container templates within the set to output a merged container template 250.

The PCTGM 200 may receive a sample project set 210 as an input. A sample project set 210 may include one or more sample projects. In some embodiments, many sample projects may be included in a set; for the sake of simplicity, the sample project set 210 shown includes three sample projects: sample project A 202, sample project B 204, and sample project C 206. Each sample project contains project data; the project data may be depicted as shown in sample project C 206 such that the project code, like code, and configuration 212 are in a grouping of project data and the dockerfile 214 (or other command file) are in another grouping of project data.

The PCTGM 200 may extract feature nodes from the sample project set 210 to obtain extracted feature nodes 220. The PCTGM 200 may extract features as feature nodes from the project code and corresponding command file (e.g., dockerfile). The feature nodes may include, for example, the programming language, dependencies, entry command, environments, and the like. The extracted feature nodes 220 include feature nodes from each project grouped together such that the feature nodes from sample project A 202 are extracted into project A nodes 222, from sample project B 204 are extracted into project B nodes 224, and from sample project C 206 are extracted into project C nodes 226.

The PCTGM 200 may then classify the extracted feature nodes 220 and build a template graph for each set of feature nodes to obtain a container template set 230. An automatic nodes classifier 246 may be used to automatically classify the nodes into defined schemas; the automatic nodes classifier may automatically cluster the nodes directly from the project code (and/or from the group of extracted feature nodes for the project) into certain graphs.

The container template set 230 may include a container template for each set of project feature nodes. The container template set 230 includes project A container template 232 derived from the classification of the project A nodes 222, project B container template 234 derived from the classification of the project B nodes 224, and project C container template 236 derived from the classification of the project C nodes 226. Each of the project container templates includes nodes graphed based on the individual project, as shown in the project C container template 236.

The project C container template 236 shows a central node, that is, project C core node 242. The other nodes are feature nodes of project C 242 clustered into like groups. For example, the code features 244 are shown clustered together with an arrow hatch pattern. Similarly, other nodes are grouped together. For example, the sparse dot pattern may represent environment nodes, the dashed pattern may represent version nodes, the dense dot pattern may represent dependency nodes, the rounded hatch pattern may represent image nodes, the double-dash pattern may represent command nodes, the crosshatch pattern may represent compile tool nodes, and the pinstripe pattern may represent other nodes.

Each project container template may have the same, similar, or substantially different node graphs depending on the project, its code, like code, configuration, command file, and the feature nodes extracted therefrom. Node graphs may have different numbers of nodes, and/or the number of nodes within each group may differ; for example, one project may have three images whereas another project may have fifty-seven images. Node graphs may have different layouts; for example, one project may have a first dependency node and two dependency nodes immediately dependent therefrom whereas another project may have only one dependency node and yet another project may have cross-dependencies such that sub-nodes are dependent on both a parent node as well as each other.

The PCTGM 200 may then use a project container template generator to cluster and merge duplicative templates of the container template set 230. The project container template generator may base the clustering on the graphs and command files generated by the automatic node classifier 246. The output may be an abstract project container template that includes an abstract graph and a corresponding command file template.

In the embodiment shown, the three container templates are duplicative of each other and are each merged into a merged container template 250 for a project 252 with code features 254. The merged container template 250 includes an automatic node classifier 256. In some embodiments of the present disclosure, the PCTGM 200 may receive many sample projects, build many container templates, and all of the container templates may be distinct (as in, the PCTGM 200 may not have any duplicative templates to merge). In some embodiments, the PCTGM 200 may receive many sample projects and all of the container templates may be merged into one as all of the sample projects may render the same container template. In some embodiments, the PCTGM 200 may receive only one sample project as input and generate only one container template output such that there are no templates to merge.

The merged container template 250 may have the same or a different number of nodes as the templates merged; for example, several projects may have the same template even though one of the projects has an additional version node or image node.

FIG. 3 illustrates a TMCGM 300 architecture in accordance with some embodiments of the present disclosure. The TMCGM 300 may receive a sample project 310 with project code, like code, and configuration. The TMCGM 300 may analyze the project source code, match the project source code with an existing project container template, and generate a command file (e.g., a dockerfile 360) based on the matched project container template.

The TMCGM 300 may receive a sample project 310 (e.g., a new project code such as new project code 128 as shown in FIG. 1) and extract feature nodes 320 therefrom. The feature nodes 320 may include, for example, environment A, environment B, language, a first dependency, a second dependency, a third dependency, a base image, and a compile tool node as shown in FIG. 3. The feature nodes 320 may include a different number (e.g., five base images) and/or different types (e.g., versions and/or commands) of nodes.

The TMCGM 300 may use a node classifier (e.g., node classifier 132 of FIG. 1) to classify the feature nodes 320 into defined schemas to build a project instance 340 of the sample project 310. As shown in this embodiment, the sparse dot pattern may represent environment nodes, the double-dash pattern may represent command nodes, the dense dot pattern may represent dependency nodes, the rounded hatch pattern may represent image nodes, the dash pattern may represent version nodes, and the crosshatch pattern may represent compile tool nodes. The TMCGM 300 may use a template matcher to match the project instance 340 automatically generated by the nodes automatic classifier with an existing project container template such as project container template A 350. In some embodiments of the present disclosure, a PCTGM (such as PCTGM 200 of FIG. 2) may have built the project container template (e.g., merged container template 250 of FIG. 2).

The TMCGM 300 may produce a command file based on the matched project container template. The TMCGM 300 may use a command file generator (e.g., a dockerfile generator) to automatically generate the command file based on the project container template that was matched with the project source code; as shown in this embodiment, the TMCGM 300 generated a dockerfile 360 based on project container template A 350.

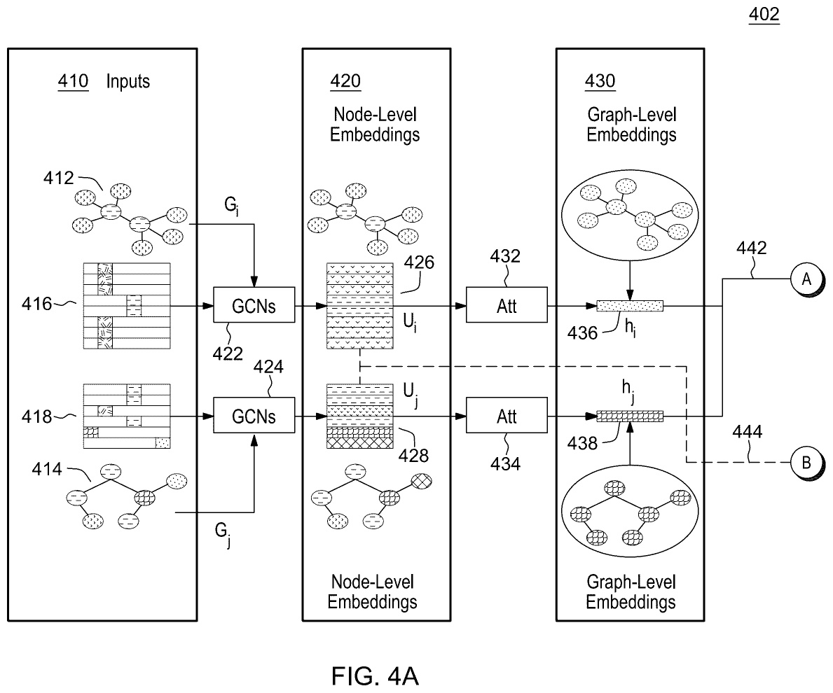

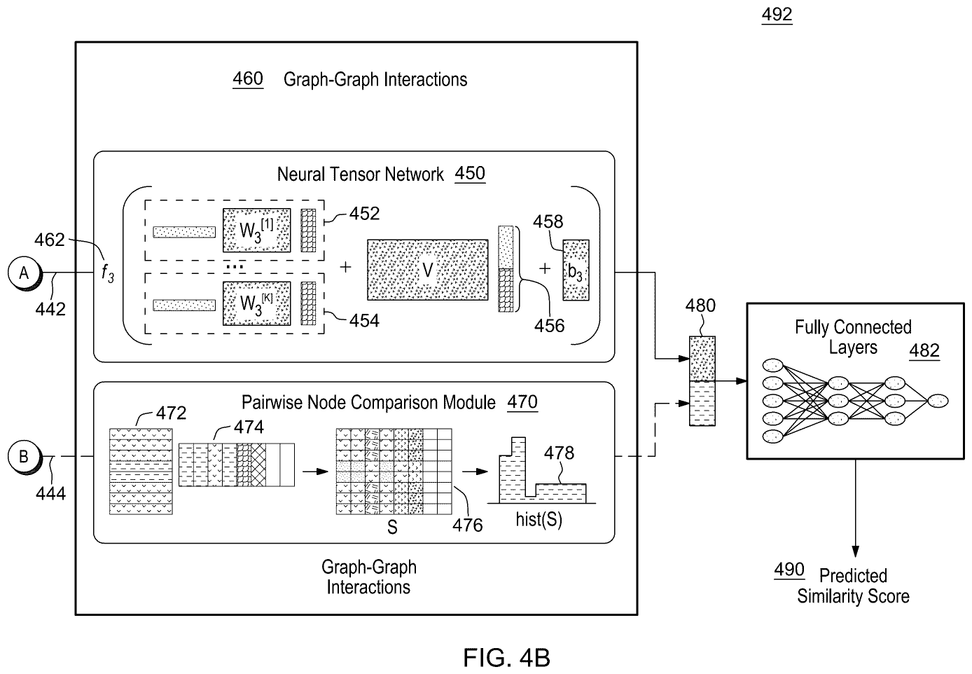

FIGS. 4A and 4B depict a flowchart of an example template matching and command file generation implementation in accordance with some embodiments of the present disclosure. The similarity between the graphs may be calculated according to the corresponding vector of the graph embedding, and the correlation or difference between two graph nodes may also be considered. Thus, a containerization engine may perform graph embedding. Graph embedding may include doing one-hot encoding to every node (wherein the same node type has the same encoding) and then use a GCN to conduct neighbor aggregation; in some embodiments, the GCN may use three layers or aggregate the characteristics of first-order neighbors of nodes. The graph embedding may include using an attention mechanism to merge node embeddings into graph embeddings.

FIG. 4A depicts a flowchart of an example graph embedding 402 in accordance with the present disclosure. A containerization engine (e.g., containerization engine 100 of FIG. 1) may have a TMCGM (e.g., TMCGM 300 of FIG. 3); the TMCGM may receive inputs 410, derive node-level embeddings 420 with one or more GCNs, and encode the node-level embeddings 420 into graph-level embeddings 430.

The inputs 410 may include a first graph 412 and a second graph 414. The first graph 412 may have a corresponding first vector 416 and the second graph 414 may have a corresponding second vector 418. The first graph 412 may be represented by the first vector 416 and the second graph 414 may be represented by the second vector 418. The first graph 412 and first vector 416 may be input into a first set of GCNs 422 and the second graph 414 and second vector 418 may be input into a second set of GCNs 424. The GCNs 422, 424 may use techniques such as three-layers or aggregation of the characteristics of first-order neighbors of nodes to obtain node-level embeddings 420 for the inputs 410. The node-level embeddings 420 may include an embedded first vector 426 and an embedded second vector 428.

The containerization engine may use one or more attention mechanisms to merge node-level embeddings 420 into graph-level embeddings 430. In the present embodiment, the embedded first vector 426 is submitted to a first attention mechanism 432 to obtain a first graph embedding 436 and the embedded second vector 428 is submitted to a second attention mechanism 434 to obtain a second graph embedding 438. The graph-level embeddings 430 may be submitted 442 to a neural tensor network (e.g., neural tensor network 450 as shown in FIG. 4B) and the node-level embeddings 420 may be submitted 444 for pairwise node comparison (e.g., to pairwise node comparison module 470 as shown in FIG. 4B).

FIG. 4B illustrates a flowchart 492 of an example template matcher and command file generation implementation in accordance with some embodiments of the present disclosure. The TMCGM (e.g., TMCGM 300 of FIG. 3) may use a neural tensor network to calculate similarity; the input may be two graph embeddings and the output may be a k-dimensional similarity vector. Graph-level embeddings (e.g., graph-level embeddings 430 of FIG. 4A) may be submitted 442 to a neural tensor network 450. The neural tensor network 450 may use an activation function f₃ 462 (e.g., ReLU) to obtain a similarity by using first-slice graph data 452 through K-slice graph data 454, a graph weight matrix V 456, and a bias term b₃ 458. The neural tensor network 450 may thus obtain a neural network output vector.

The TMCGM (e.g., TMCGM 300 of FIG. 3) may use a pairwise node comparison module 470 to perform a pairwise node comparison to consider the relationship between the two graph nodes and the graph embedding inner product, thereby obtaining a correlation matrix which may be transformed into histogram feature. The node-level embeddings (e.g., node-level embeddings 420 of FIG. 4A) may be submitted 444 to the pairwise node comparison module 470. The pairwise node comparison module 470 may consider the relationship between the graphs of the node-level embeddings 420 by taking the inner product of the first node-level graph embedding 472 and the second node-level graph embedding 474 to obtain a correlation matrix S 476. The correlation matrix S 476 may be transformed into a histogram hist(S) 478. The pairwise node comparison module 470 may thus obtain a pairwise similarity of node histogram characteristics output vector.

The neural network output vector and the pairwise similarity of node characteristics output vector may be combined to form a comparison vector 480. The TMCGM may use the comparison vector 480 to obtain the final dimension compressed similarity score by using several layers of the link layer. The TMCGM may use the comparison vector 480 as input to generate fully connected layers 482. The fully connected layers 482 may be used to obtain a predicted similarity score 490.

FIG. 5 depicts a REM 500 architecture in accordance with some embodiments of the present disclosure. The REM 500 may receive a sample project 510 with a project code 512, a like code 514, and a configuration 516. The REM 500 may generate 518 a command file 520 from the data of the sample project 510; in some embodiments, the REM 500 may use a build and execution module (e.g., build and execution module 144 of FIG. 1) to generate the command file 520.

The REM 500 may identify and correct 528 any errors automatically to obtain a corrected command file 530. In some embodiments, REM 500 may include an automatic error correction component to correct the command file 520 (e.g., dockerfile); the REM 500 may use an automatic error correction component (e.g., automatic error correction module 144 of FIG. 1) to identify and correct 528 the errors. The REM 500 may optimize 538 the command file 520 to obtain an optimized command file 540; in some embodiments, the REM 500 may use an automatic error correction component to optimize 538 the command file 520.

The REM 500 may use the optimized command file 540 to build and execute 548 an executed command file 550; the executed command file 550 may include a container image 552 and a container 554. In some embodiments, the REM 500 may use a build and execution module (e.g., build and execution module 144 of FIG. 1) to build and execute 548 the executed command file 550.

In some embodiments, the REM 500 may automatically identify and correct errors 558 in the executed command file 550. The REM 500 may loop back to a new optimized command file 540 and re-build and re-execute the optimized command file 540 to obtain a corrected executed command file. In some embodiments, the REM 500 may automatically update the command file 520 to generate a new container image 552 and start a container 554 to provide secured, optimized applications and/or services.

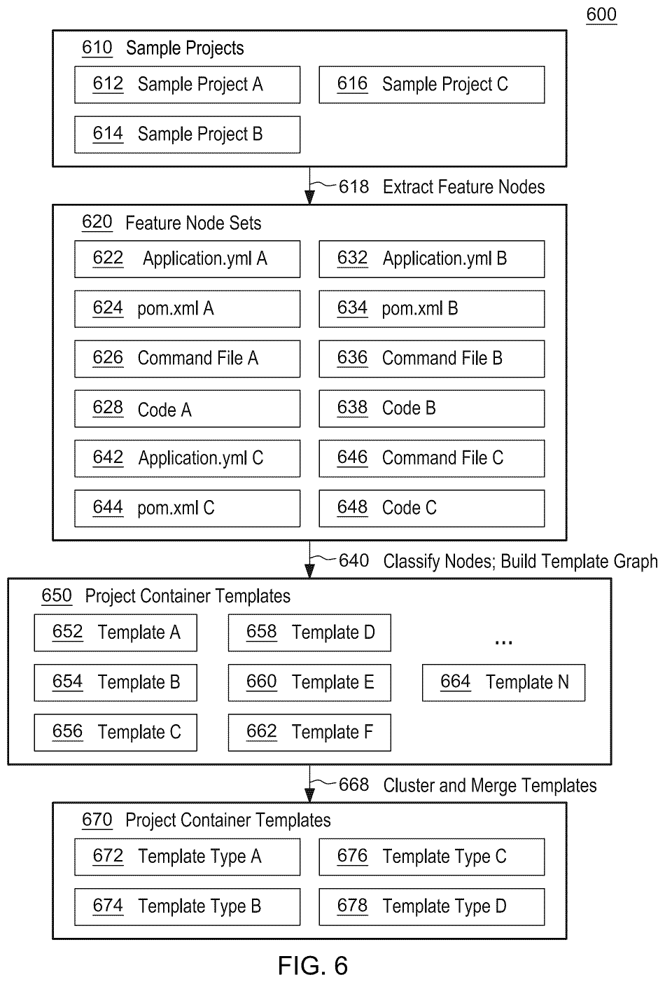

FIG. 6 illustrates a first example implementation 600 of a containerization engine in accordance with some embodiments of the present disclosure. In the first example implementation 600, a PCTGM (e.g., the PCTGM 200 of FIG. 2) receives sample projects 610 including sample project A 612, sample project B 614, and sample project C 616. The PCTGM extracts 618 feature nodes from the sample projects 610 into feature node sets 620. The feature node sets 620 include feature nodes from each of the sample projects 610. The sample project A 612 feature nodes include application.yml A 622, pom.xml A 624, command file A 626, and code A 628, the sample project B 614 feature nodes include application.yml B 632, pom.xml B 634, command file B 636, and code B 638, and the sample project C 612 feature nodes include application.yml C 642, pom.xml C 644, command file C 646, and code C 648.

The PCTGM classifies the feature nodes and builds one or more template graphs 640 based on the feature node sets 620. The PCTGM may use an automatic nodes classifier (e.g., node classifier 112 of FIG. 1) to automatically classify the feature nodes. The PCTGM may use a project container template generator (e.g., project container template generator 114 of FIG. 1) to automatically build the one or more template graphs, for example, from the output of the automatic nodes classifier.

The PCTGM obtains project container templates 650 from classifying the feature nodes and building the template graphs. The project container templates 650 in this embodiment include template A 652, template B 654, template C 656, template D 658, template E 660, template F 662, and template N 664. The PCTGM then clusters and merges the templates 668 to obtain a set of project container templates 670 without redundant templates. The project container templates 670 includes project template type A 672, project template type B 674, project template type C 676, and project template type D 678.

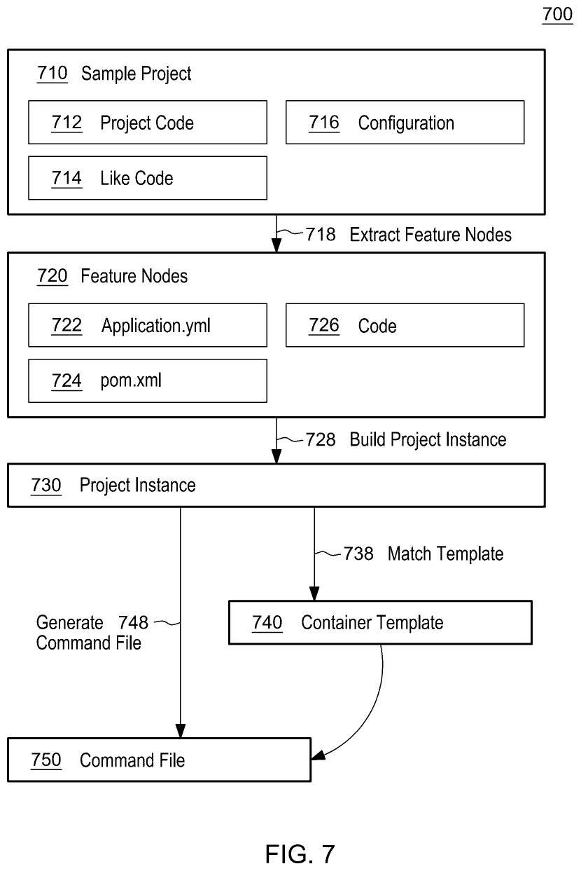

FIG. 7 depicts a second example implementation 700 of a containerization engine in accordance with some embodiments of the present disclosure. In the second example implementation 700, a TMCGM receives a sample project 710 with a project code 712, like code 714, and a configuration 716. The TMCGM extracts 718 the feature nodes from the sample project 710 to obtain feature nodes 720. In this embodiment, the feature nodes 720 include application.yml 722, pom.xml 724, and code 726. In some embodiments, the TMCGM may use a node classifier (e.g., node classifier 132 of FIG. 1) to classify the feature nodes. The TMCGM then builds 728 the project instance 730 using the feature nodes 720.

The TMCGM matches 738 the project instance 730 to a container template 740. In some embodiments, the TMCGM may use a template matcher (e.g., template matcher 134 of FIG. 1) to match the project instance 730 to a container template 740.

The TMCGM generates 748 a command file 750 for the project instance 730. In some embodiments, the TMCGM may use a command file generator (e.g., command file generator 136 of FIG. 1) to generate the command file 750.

A computer-implemented method in accordance with the present disclosure may include analyzing input source code and building a project instance based on the input source code. The method may include matching a project instance to a template and generating, automatically, a command file based on the template.

In some embodiments of the present disclosure, the method may further include obtaining input feature nodes from the input source code. In some embodiments, analyzing the input source code may result in obtaining the input feature nodes.

In some embodiments of the present disclosure, the method may further include extracting feature nodes from a plurality of samples, building a template graph with the feature nodes, and generating a project container template based on the template graph. In some embodiments, the plurality of samples may include sample project codes and/or sample command files. In some embodiments, building the template graph may include classifying the sample feature nodes. In some embodiments, generating a project container template may include generating a template command file. In some embodiments, multiple project container templates may be generated, and the method may include merging any duplicative templates.

In some embodiments of the present disclosure, the method may further include generating a container image based on the command file.

In some embodiments of the present disclosure, the method may further include generating a container based on the command file.

In some embodiments of the present disclosure, the method may further include detecting a problem based on the command file; in some embodiments, the problem may be detected automatically. In some embodiments, the method may further include identifying a solution to the problem; in some embodiments, the solution may be identified automatically. In some embodiments, the method may further include correcting the problem using the solution; in some embodiments, the problem may be corrected using the solution automatically.

A computer-implemented method in accordance with the present disclosure may include extracting feature nodes from a project code and classifying the feature nodes into defined schemas using a node classifier to obtain categorized feature nodes. The method may include clustering the categorized feature nodes into a project container template using a project container template generator and automatically generating a file based on the project container template.

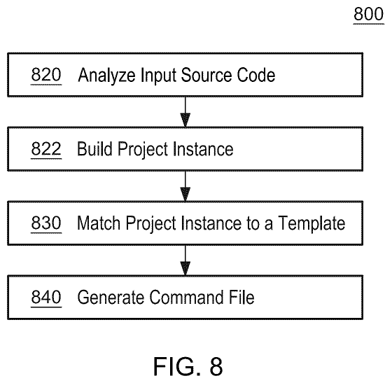

FIG. 8 illustrates a computer-implemented method 800 of containerization using a containerization engine in accordance with some embodiments of the present disclosure. The method 800 may be implemented by a containerization engine (such as containerization engine 100 shown in FIG. 1). The method 800 includes analyzing 820 an input source code. The method 800 also includes building 822 a project instance with the input source code. The method 800 further includes matching 830 the project instance to a template. The method 800 additionally includes generating 840 a command file.

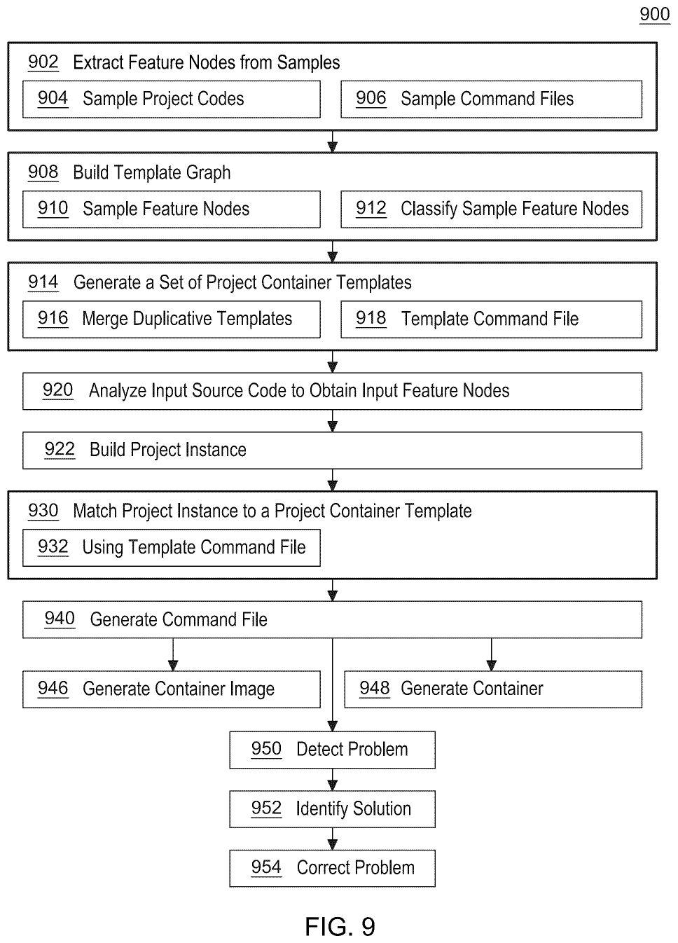

FIG. 9 depicts computer-implemented method 900 of containerization using a containerization engine in accordance with some embodiments of the present disclosure. The method 900 may be implemented by a containerization engine (such as containerization engine 100 shown in FIG. 1).

The method 900 includes extracting 902 feature nodes from samples. The samples may include sample project codes 904 and/or sample command files 906. The sample project codes 904 may include, for example, application codes (e.g., application.yml files), pom codes (e.g., pom.xml codes), and/or other codes and/or code files from a project (e.g., a java project). The sample command files 906 may include, for example, dockerfiles and/or other instructions (e.g., instructions to build an image, a definition of an image, or a script to generate a container).

The method 900 includes building 908 a template graph. The method 900 may build the template graph using sample feature nodes 910. The method 900 may include classifying 912 the extracted sample feature nodes 910 to build the template graph. For example, the method 900 may include accepting samples as an input, extracting 902 feature nodes from the samples, and building 908 the template graph therefrom by classifying 912 the sample feature nodes 910.

The method 900 includes generating 914 a set of project container templates. In some embodiments, the method 900 may include generating 914 a single project container template; as in, a set of project container templates may consist of only one project container template in the set. In some embodiments, multiple project container templates may be generated; as in, a set of project container templates may include a plurality of project container templates in the set. Each project container template within the set may include a template command file 918; each template command file 918 may or may not be distinct from each other template command file 918 within the set of project container templates. Generating 914 a set of project container templates may include merging 916 duplicative templates; for example, if five project container templates are generated for the set but the first and second project container templates are identical, the method 900 may include merging the first and second project container templates (e.g., deleting the second project container template while retaining the first project container template).

The method 900 includes analyzing 920 an input source code. The input source code may be, for example, a project code for a new project. The input source code may be, for example, the project code for a software application or program that a development team is launching on a containerized system using a containerization engine (e.g., containerization engine 100 of FIG. 1).

The method 900 includes building 922 a project instance with the input source code. Building 922 a project instance with the input source code may include, for example, a developer submitting a new project source code as the input source code and a containerization engine (e.g., containerization engine 100 of FIG. 1) using the new project source code to build a project instance for the new project source code.

The method 900 includes matching 930 the project instance to a template. The method 900 may include generating 914 a set of project container templates, building 922 a project instance, and matching 930 the project instance with an appropriate project container template within the set of project container templates. The matching 930 may be based on, for example, similarities and/or differences between the project instance data (e.g., the feature nodes of the project and/or other analysis information derived from analyzing 920 the input source code) and the one or more project container templates within the set of project container templates. In some embodiments, the matching 930 may be performed by using 932 a template command file; in some embodiments, the project instance may be matched to a template command file, and the template command file may be used to match the project to a project container template.

The method 900 includes generating 940 a command file. The command file may include, for example, one or more dockerfiles and/or one or more other instructions (e.g., instructions to build an image, a definition of an image, or a script to generate a container).

The method 900 includes generating 946 a container image. The container image may be generated specifically for the project instance and/or based on the project container template matched to the project instance. The container image may be generated based on the command file generated for the project instance.

The method 900 includes generating 948 a container. The container may be generated specifically for the project instance and/or based on the project container template matched to the project instance. The container may be generated based on the command file generated for the project instance.

In some embodiments, the present disclosure enables automatic detection and resolution of a problem. The method 900 includes detecting 950 a problem. In some circumstances, a problem may be detected; for example, a template command file may not be executable because of a recent update or a container image may be incompatible with a newly-launched security measure. The method 900 includes identifying 952 a solution to the problem (e.g., a new version of the template command file or a different container image). The method 900 includes correcting 954 the problem (e.g., implementing the identified solution).

In some embodiments, the method 900 may automatically detect a problem, identify a solution, and correct the problem with the identified solution. In some embodiments, the method 900 may detect a problem automatically and notify an administrator of the problem; in some embodiments, the method 900 may detect a problem automatically, identify one or more solutions automatically, notify an administrator of the problem, and offer the identified solutions (e.g., enable the administrator to choose which solution is preferable); the method 900 may include recommending a course of action (e.g., a particular solution) to the administrator. The method 900 may detect a problem automatically, identify one or more solutions automatically, notify an administrator of the problem, and request permission to automatically correct the problem.

A computer program product in accordance with the present disclosure may include a computer readable storage medium having program instructions embodied therewith. The program instructions may be executable by a processor to cause the processor to perform a function. The function may include analyzing input source code and building a project instance based on the input source code. The function may include matching a project instance to a template and generating, automatically, a command file based on the template.

In some embodiments of the present disclosure, the function may further include obtaining input feature nodes from the input source code. In some embodiments, analyzing the input source code may result in obtaining the input feature nodes.

In some embodiments of the present disclosure, the function may further include extracting feature nodes from a plurality of samples, building a template graph with the feature nodes, and generating a project container template based on the template graph. In some embodiments, the plurality of samples may include sample project codes and/or sample command files. In some embodiments, building the template graph may include classifying the sample feature nodes. In some embodiments, generating a project container template may include generating a template command file. In some embodiments, multiple project container templates may be generated, and the function may include merging any duplicative templates.

In some embodiments of the present disclosure, the function may further include generating a container image based on the command file.

In some embodiments of the present disclosure, the function may further include generating a container based on the command file.

In some embodiments of the present disclosure, the function may further include detecting a problem based on the command file; in some embodiments, the problem may be detected automatically. In some embodiments, the function may further include identifying a solution to the problem; in some embodiments, the solution may be identified automatically. In some embodiments, the function may further include correcting the problem using the solution; in some embodiments, the problem may be corrected using the solution automatically.

It is noted that various aspects of the present disclosure may be described by narrative text, flowcharts, block diagrams of computer systems, and/or block diagrams of the machine logic included in computer program product (CPP) embodiments. With respect to any flowcharts (depending upon the technology involved), the operations can be performed in a different order than what is shown in the flowchart. For example, two operations shown in successive flowchart blocks may be performed in reverse order, as a single integrated step, concurrently, or in a manner at least partially overlapping in time. A computer program product embodiment (“CPP embodiment”) is a term used in the present disclosure that may describe any set of one or more storage media (or “mediums”) collectively included in a set of one or more storage devices.

The storage media may collectively include machine readable code corresponding to instructions and/or data for performing computer operations. A “storage device” may refer to any tangible hardware or device that can retain and store instructions for use by a computer processor. Without limitation, the computer readable storage medium may include an electronic storage medium, a magnetic storage medium, an optical storage medium, an electromagnetic storage medium, a semiconductor storage medium, a mechanical storage medium, and/or any combination thereof. Some known types of storage devices that include mediums referenced herein may include a diskette, hard disk, random access memory (RAM), read-only memory (ROM), erasable programmable read-only memory (EPROM or Flash memory), static random-access memory (SRAM), compact disc read-only memory (CD-ROM), digital versatile disk (DVD), memory stick, floppy disk, mechanically encoded device (such as punch cards or pits/lands formed in a major surface of a disc), or any suitable combination thereof. A computer-readable storage medium should not be construed as storage in the form of transitory signals per se such as radio waves, other freely propagating electromagnetic waves, electromagnetic waves propagating through a waveguide, light pulses passing through a fiber optic cable, electrical signals communicated through a wire, and/or other transmission media. As understood by those skilled in the art, data is typically moved at some occasional points in time during normal operations of a storage device, such as during access, de-fragmentation, or garbage collection, but this does not render the storage device transitory because the data is not transitory while it is stored.

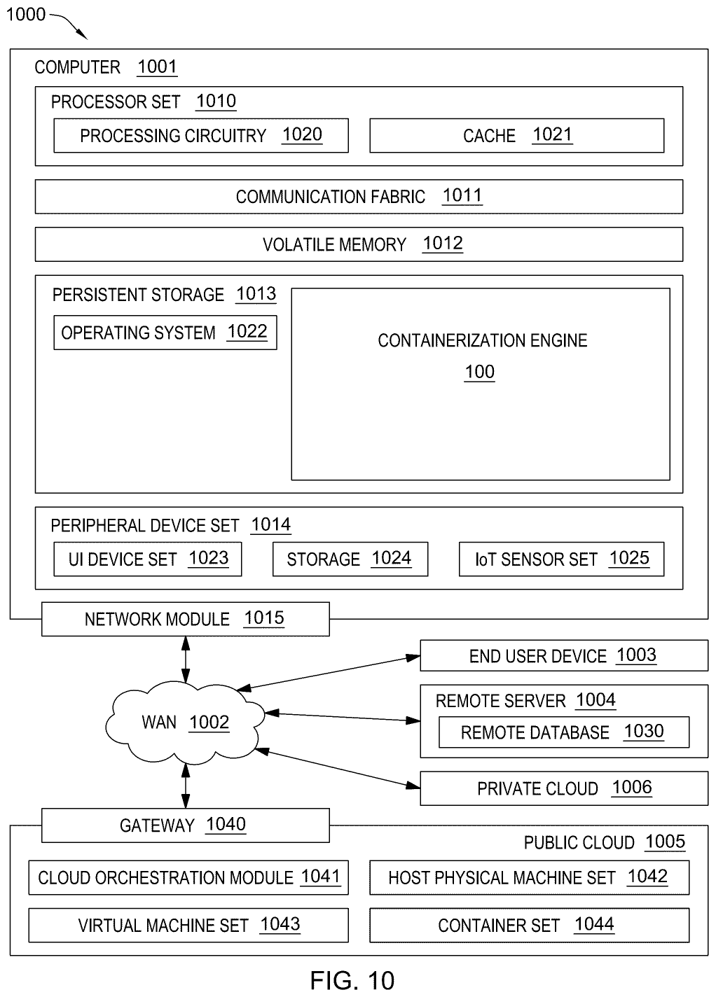

FIG. 10 is an example diagram of a distributed data processing system environment in which aspects of the illustrative embodiments may be implemented and at least some of the computer code involved in performing the inventive methods may be executed. That is, computing environment 1000 contains an example of an environment for the execution of at least some of the computer code involved in performing the inventive methods, such as the containerization engine 100 which may include a PCTGM (e.g., PCTGM 200 of FIG. 2), a TMCGM (e.g., TMCGM 300 of FIG. 3), and a REM (e.g., REM 500 of FIG. 5). In addition to the containerization engine 100, computing environment 1000 includes, for example, computer 1001, wide area network (WAN) 1002, end user device (EUD) 1003, remote server 1004, public cloud 1005, and private cloud 1006. In this embodiment, computer 1001 includes processor set 1010 (including processing circuitry 1020 and cache 1021), communication fabric 1011, volatile memory 1012, persistent storage 1013 (including operating system 1022 and the containerization engine 100, as identified above), peripheral device set 1014 (including user interface (UI) device set 1023, storage 1024, and Internet of Things (IoT) sensor set 1025), and network module 115. Remote server 1004 includes a remote database 1030. Public cloud 1005 includes gateway 1040, cloud orchestration module 1041, host physical machine set 1042, virtual machine set 1043, and container set 1044.

Computer 1001 may take the form of a desktop computer, laptop computer, tablet computer, smart phone, smart watch, or other wearable computer, mainframe computer, quantum computer, or any other form of computer or mobile device now known or to be developed in the future that is capable of running a program, accessing a network, or querying a database such as remote database 1030. As is well understood in the art of computer technology, and depending upon the technology, performance of a computer-implemented method may be distributed among multiple computers and/or between multiple locations. On the other hand, in this presentation of computing environment 1000, detailed discussion is focused on a single computer, specifically computer 1001, to keep the presentation as simple as possible. Computer 1001 may be located in a cloud, even though it is not shown in a cloud in FIG. 1. On the other hand, computer 1001 is not required to be in a cloud except to any extent as may be affirmatively indicated.

Processor set 1010 includes one, or more, computer processors of any type now known or to be developed in the future. Processing circuitry 1020 may be distributed over multiple packages, for example, multiple, coordinated integrated circuit chips. Processing circuitry 1020 may implement multiple processor threads and/or multiple processor cores. Cache 1021 is memory that is located in the processor chip package(s) and is typically used for data or code that should be available for rapid access by the threads or cores running on processor set 1010. Cache memories are typically organized into multiple levels depending upon relative proximity to the processing circuitry. Alternatively, some, or all, of the cache for the processor set may be located “off chip.” In some computing environments, processor set 1010 may be designed for working with qubits and performing quantum computing.

Computer readable program instructions are typically loaded onto computer 1001 to cause a series of operational steps to be performed by processor set 1010 of computer 1001 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 1021 and the other storage media discussed below. The program instructions, and associated data, are accessed by processor set 1010 to control and direct performance of the inventive methods. In computing environment 1000, at least some of the instructions for performing the inventive methods may be stored in a containerization engine 100 in persistent storage 1013.

Communication fabric 1011 is the signal conduction paths that allow the various components of computer 1001 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 1012 is any type of volatile memory now known or to be developed in the future. Examples include dynamic type random access memory (RAM) or static type RAM. Typically, the volatile memory is characterized by random access, but this is not required unless affirmatively indicated. In computer 1001, the volatile memory 1012 is located in a single package and is internal to computer 1001, but, alternatively or additionally, the volatile memory may be distributed over multiple packages and/or located externally with respect to computer 1001.

Persistent storage 1013 is any form of non-volatile storage for computers that is now known or to be developed in the future. The non-volatility of this storage means that the stored data is maintained regardless of whether power is being supplied to computer 101 and/or directly to persistent storage 1013. Persistent storage 1013 may be a read only memory (ROM), but typically at least a portion of the persistent storage allows writing of data, deletion of data and re-writing of data. Some familiar forms of persistent storage include magnetic disks and solid state storage devices. Operating system 1022 may take several forms, such as various known proprietary operating systems or open source Portable Operating System Interface type operating systems that employ a kernel. The code included in a containerization engine 100 typically includes at least some of the computer code involved in performing the inventive methods.

Peripheral device set 1014 includes the set of peripheral devices of computer 1001. Data communication connections between the peripheral devices and the other components of computer 1001 may be implemented in various ways, such as Bluetooth connections, Near-Field Communication (NFC) connections, connections made by cables (such as universal serial bus (USB) type cables), insertion type connections (for example, secure digital (SD) card), connections made through local area communication networks and even connections made through wide area networks such as the internet. In various embodiments, UI device set 1023 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 1024 may be persistent and/or volatile. In some embodiments, storage 1024 may take the form of a quantum computing storage device for storing data in the form of qubits. In embodiments where computer 1001 is required to have a large amount of storage (for example, where computer 1001 locally stores and manages a large database) then this storage may be provided by peripheral storage devices designed for storing very large amounts of data, such as a storage area network (SAN) that is shared by multiple, geographically distributed computers. IoT sensor set 1025 is made up of sensors that can be used in Internet of Things applications. For example, one sensor may be a thermometer and another sensor may be a motion detector.

Network module 1015 is the collection of computer software, hardware, and firmware that allows computer 1001 to communicate with other computers through WAN 1002. Network module 1015 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 1015 are performed on the same physical hardware device. In other embodiments (for example, embodiments that utilize software-defined networking (SDN)), the control functions and the forwarding functions of network module 1015 are performed on physically separate devices, such that the control functions manage several different network hardware devices. Computer readable program instructions for performing the inventive methods can typically be downloaded to computer 1001 from an external computer or external storage device through a network adapter card or network interface included in network module 1015.

WAN 1002 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 1003 is any computer system that is used and controlled by an end user (for example, a customer of an enterprise that operates computer 1001), and may take any of the forms discussed above in connection with computer 1001. EUD 1003 typically receives helpful and useful data from the operations of computer 1001. For example, in a hypothetical case where computer 1001 is designed to provide a recommendation to an end user, this recommendation would typically be communicated from network module 1015 of computer 1001 through WAN 1002 to EUD 1003. In this way, EUD 1003 can display, or otherwise present, the recommendation to an end user. In some embodiments, EUD 1003 may be a client device, such as thin client, heavy client, mainframe computer, desktop computer and so on.

Remote server 1004 is any computer system that serves at least some data and/or functionality to computer 1001. Remote server 1004 may be controlled and used by the same entity that operates computer 1001. Remote server 1004 represents the machine(s) that collect and store helpful and useful data for use by other computers, such as computer 1001. For example, in a hypothetical case where computer 1001 is designed and programmed to provide a recommendation based on historical data, then this historical data may be provided to computer 1001 from remote database 1030 of remote server 1004.

Public cloud 1005 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 1005 is performed by the computer hardware and/or software of cloud orchestration module 1041. The computing resources provided by public cloud 1005 are typically implemented by virtual computing environments that run on various computers making up the computers of host physical machine set 1042, which is the universe of physical computers in and/or available to public cloud 1005. The virtual computing environments (VCEs) typically take the form of virtual machines from virtual machine set 1043 and/or containers from container set 1044. It is understood that these VCEs may be stored as images and may be transferred among and between the various physical machine hosts, either as images or after instantiation of the VCE. Cloud orchestration module 1041 manages the transfer and storage of images, deploys new instantiations of VCEs and manages active instantiations of VCE deployments. Gateway 1040 is the collection of computer software, hardware, and firmware that allows public cloud 1005 to communicate through WAN 1002.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 1006 is similar to public cloud 1005, except that the computing resources are only available for use by a single enterprise. While private cloud 1006 is depicted as being in communication with WAN 1002, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 1005 and private cloud 1006 are both part of a larger hybrid cloud.

As shown in FIG. 1, one or more of the computing devices, e.g., computer 1001 or remote server 1004, may be specifically configured to implement a containerization engine 100. The configuring of the computing device may comprise the providing of application specific hardware, firmware, or the like to facilitate the performance of the operations and generation of the outputs described herein with regard to the illustrative embodiments. The configuring of the computing device may also, or alternatively, comprise the providing of software applications stored in one or more storage devices and loaded into memory of a computing device, such as computer 1001 or remote server 1004, for causing one or more hardware processors of the computing device to execute the software applications that configure the processors to perform the operations and generate the outputs described herein with regard to the illustrative embodiments. Moreover, any combination of application specific hardware, firmware, software applications executed on hardware, or the like, may be used without departing from the spirit and scope of the illustrative embodiments.

It should be appreciated that once the computing device is configured in one of these ways, the computing device becomes a specialized computing device specifically configured to implement the mechanisms of the illustrative embodiments and is not a general purpose computing device. Moreover, as described above, the implementation of the mechanisms of the illustrative embodiments improves the functionality of the computing device and provides a useful and concrete result that enables automatically building container images and executing containers based on source codes. This enables users to focus on a desired area (e.g., developing a software tool or program) without sacrificing efficiency, security, or other resources.

Although the present disclosure has been described in terms of specific embodiments, it is anticipated that alterations and modifications thereof will become apparent to the skilled in the art. The descriptions of the various embodiments of the present disclosure have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application, or the technical improvement over technologies found in the marketplace or to enable others of ordinary skill in the art to understand the embodiments disclosed herein. Therefore, it is intended that the following claims be interpreted as covering all such alterations and modifications as fall within the true spirit and scope of the disclosure.

What is claimed is:

1. A system comprising:
a memory; and
a processor in communication with said memory, said processor being configured to perform operations, said operations comprising:
analyzing input source code;
building a project instance based on said input source code;
matching a project instance to a template; and
generating, automatically, a command file based on said template.

2. The system of claim 1, said operations further comprising:
obtaining input feature nodes from said input source code.

3. The system of claim 1, said operations further comprising:
extracting feature nodes from a plurality of samples;
building a template graph with said feature nodes; and
generating a project container template based on said template graph.

4. The system of claim 1, said operations further comprising:
generating a container image based on said command file.

5. The system of claim 1, said operations further comprising:
generating a container based on said command file.

6. The system of claim 1, said operations further comprising:
detecting a problem based on said command file;
identifying a solution to said problem; and
correcting said problem using said solution.

7. A method comprising:
analyzing input source code;
building a project instance based on said input source code;
matching a project instance to a template; and
generating, automatically, a command file based on said template.

8. The method of claim 7, further comprising:
obtaining input feature nodes from said input source code.

9. The method of claim 7, further comprising:
extracting feature nodes from a plurality of samples;
building a template graph with said feature nodes; and
generating a project container template based on said template graph.

10. The method of claim 7, further comprising:
generating a container image based on said command file.

11. The method of claim 7, further comprising:
generating a container based on said command file.

12. The method of claim 7, further comprising:
detecting a problem based on said command file.

13. The method of claim 12, further comprising:
identifying a solution to said problem.

14. The method of claim 13, further comprising:
correcting said problem using said solution.

15. A computer program product comprising a computer readable storage medium having program instructions embodied therewith, said program instructions executable by a processor to cause said processor to perform a function, said function comprising:
analyzing input source code;
building a project instance based on said input source code;
matching a project instance to a template; and
generating, automatically, a command file based on said template.

16. The computer program product of claim 15, said function further comprising:
obtaining input feature nodes from said input source code.

17. The computer program product of claim 15, said function further comprising:
extracting feature nodes from a plurality of samples;
building a template graph with said feature nodes; and
generating a project container template based on said template graph.

18. The computer program product of claim 15, said function further comprising:
generating a container image based on said command file.

19. The computer program product of claim 15, said function further comprising:
generating a container based on said command file.

20. The computer program product of claim 15, said function further comprising:
detecting a problem based on said command file;
identifying a solution to said problem; and
correcting said problem using said solution.
